(19) United States
(12) Patent Application Publication
(10) Pub. No.: US 2011/0050651 A1
(43) Pub. Date: Mar. 3, 2011

(54) LED Stylus Pen

(76) Inventor: Eric Chen, Taipei (TW)

(21) Appl. No.: 12/550,353

(22) Filed: Aug. 29, 2009

(51) Int. Cl. G06F 3/033

(52) U.S. Cl. 345/179

(57) ABSTRACT

The present invention discloses structure improvement of an LED stylus pen, wherein a button is defined at topmost of the stylus pen. When a user pushes down the button and actuates the switch of the LED, and when the user uses the writing nib to touch the touch screen again, so as to power to an LED to emit light.

### BACKGROUND OF THE INVENTION

a) Field of the Invention

The present invention relates to an LED stylus pen, and more particularly to an LED stylus pen wherein a button is defined at topmost of the stylus pen and when the button is pushed down, a switch is actuated to provide power for the LED to emit light.

b) Description of the Prior Art

An ordinary conventional stylus pen is used for touching a touch screen, allowing an LED at a front end of the stylus pen to emit light. The LED light will be emitted as long as the stylus pen touches the touch screen; however, sometimes a user will not want that the light is emitted when touching the touch screen due to work, therefore, the conventional stylus pen cannot comply with the user's requirement. Furthermore, conventional LED is used for touching a touch screen, which is easy to scratch a surface of screen. In addition, two ordinary 1.5V batteries used to supply power will have an insufficient electric current as electricity is consumed, resulting in degeneration of LED brightness or even ill induction or power-down.

### SUMMARY OF THE INVENTION

The primary object of the present invention to provide an LED stylus pen wherein a button is fitted on top of the stylus pen, a circuit board is fitted on interior of the lamp tube, a writing nib is connected to the end of the lamp tube, the LED at one end of the circuit board is located in the lamp tube. As the LED light is emitted in a tube of the writing nib which is used to replace the LED when the touch screen is touched, it can avoid scratching the screen. When the button is pushed down to turn on an LED switch that a conductive spring is pressed down to touch an anode of a battery, and if the writing nib touches a touch screen such that a conductor touches a cathode of the battery, then the LED can emit light. Therefore, the pen of the present invention is provided with an effect to control the LED to emit light by touching.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of the present invention.

FIG. 2 shows an exploded view of the present invention.

FIG. 2-1 shows a front elevational view of the circuit board of the present invention.

FIG. 2-2 shows a rear elevational view of the circuit board of the present invention.

FIG. 3 shows a cross-sectional view of the present invention.

FIG. 4 shows a cross-sectional view of the present invention, wherein a button is pushed down to turn on an LED switch.

FIG. 5 shows a cross-sectional view of the present invention, wherein a touch screen is touched to allow an LED to emit light.

FIG. 6 shows an exploded view of an embodiment of the present invention.

FIG. 7 shows a cross-sectional view of an embodiment of the present invention.

FIG. 8 shows a cross-sectional view of an embodiment of the present invention, wherein a button is pushed down to turn on an LED switch.

FIG. 9 shows a cross-sectional view of an embodiment of the present invention, wherein a touch screen is touched to allow an LED to emit light.

### DETAILED DESCRIPTION OF THE PREFERRED EMBODIMENTS

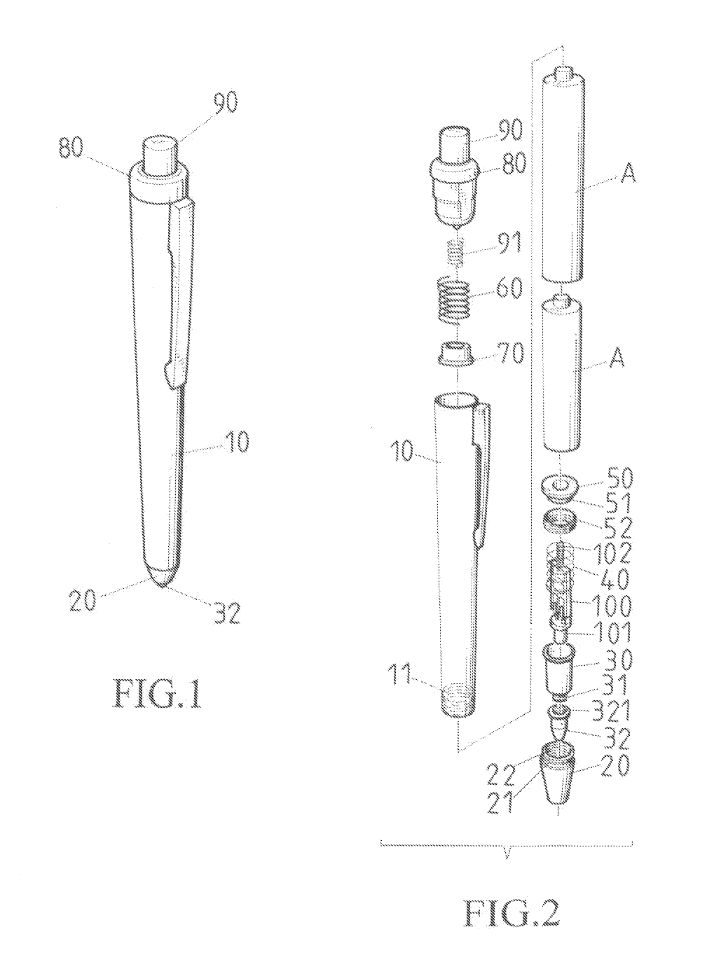

Referring to FIGS. 1 to 3, the present invention comprises a penholder 10, a pen nib 20, a lamp tube 30, a first spring 40, a first insulator 50, a second spring 60, a second insulator 60, a metal tube 80 and a button 90.

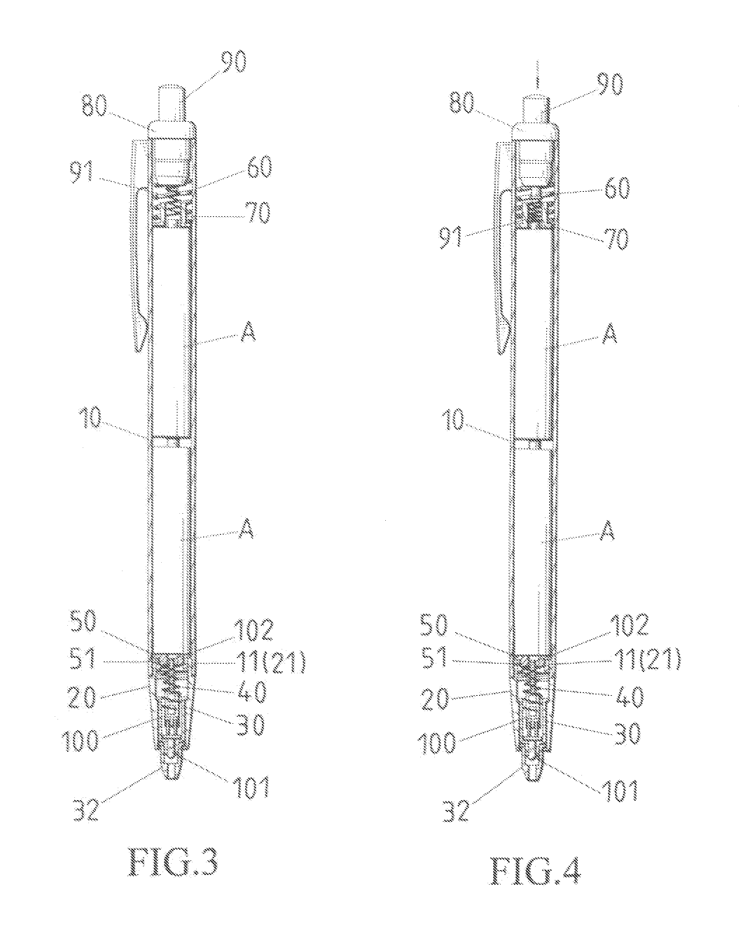

A lower side of the hollow penholder 10 is connected to the pen nib 20, an upper side is connected to the metal tube 80, and the hollow pen nib 20 is fixed by locking an outer thread 21 on a top end with an inner thread 11 at an inner rim of a bottom end of the penholder 10 (as shown in FIG. 3). The hollow lamp tube 30 is located in a pen nib 20. The helical-shaped first spring 40 is sheathed at an exterior side of the conductor 32 and is locked into the lamp tube 30. The first insulator 50 is latched on an opening end at a top end of the pen nib 20. The aforementioned parts are assembled and extended into the penholder 10, and are located below two 1.5V batteries A which are serially connected in the penholder 10. The lower-side battery A is abutted above the first insulator 50 and the upper-side battery A is abutted below the second insulator 70 on which is sheathed with the second spring 60.

A tube opening above the penholder 10 is latched with the hollow metal tube 80 which is in contact with the inner rim of the penholder 10. A button 90 transfixes the metal tube 80 and a bottom end of the button 90 is sheathed with a conductive spring 91 which transfixes the hollow second spring 60 and the second insulator 70.

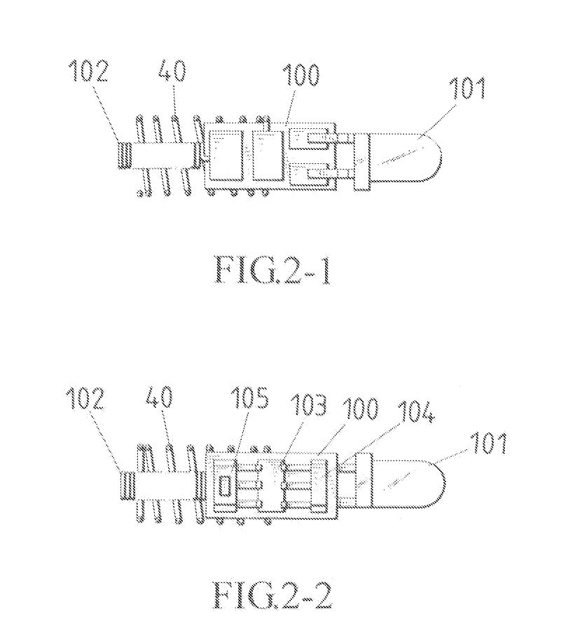

The present invention is primarily characterized in that a circuit board 100 is fitted on interior of the lamp tube 30. Referring to FIG. 2-1, the terminals at one end of circuit board 100 is in contact with the LED 101, and the other end a cathode terminals of the circuit board 100 is in contact with the conductor 102, and the central anode terminals is in contact with the first spring 40 which is sheathed above the circuit board 100. The LED 101 and the circuit board 100 are located in the hollow lamp tube 30, the screw rod 31 at one end of the lamp tube 30 is fixed by locking with a lock hole 321 of the writing nib 32, the LED 101 can not be transfixing the writing nib 32, but the light of the LED 101 can be shooting from the writing nib 32, when the lamp tube 30 and writing nib 32 are located in the pen nib 20, the writing nib 32 can be jutting out the pen nib 20. A convex periphery 51 at a lower end of the first insulator 50 is fixed with a metal screw ring 52 which is fixed by locking with a lock hole 22 of the metal pen nib 20.

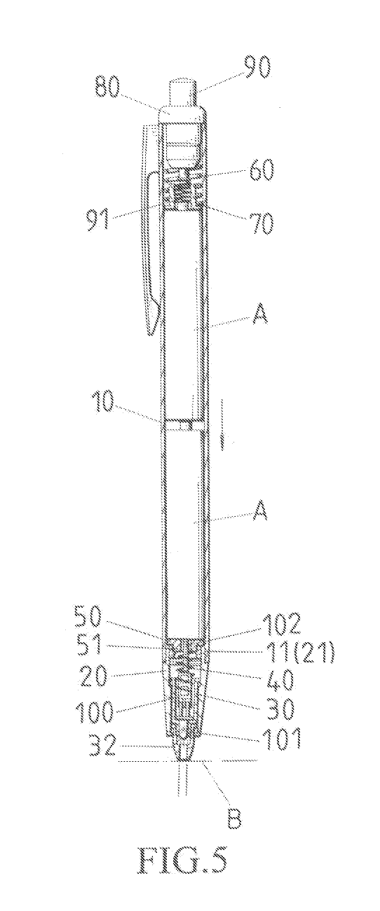

Referring to FIG. 3, in a normal time when the button 90 is not pushed down, a conductive spring 91 does not touch the battery A. Referring to FIG. 4, on the other hand, when the button 90 is pushed down, the conductive spring 91 will touch the battery A in the penholder 10. When a user presses the button 90 for a first time, the button 90 can be pushed down, and when the button 90 is pushed again, the restoring spring 91 can bounce back the button 90 to an original position.

Referring to FIG. 2-2 shows a rear elevational view of the circuit board of the present invention, a center of the circuit board 100 is provided with a booster IC 103 and two sides are provided respectively with a capacitance 104 and an inductor 105, wherein the booster IC 103 controls stability of the current, allowing a capacity of the battery A to be used to a limit. As there is no issue of touch spacing when the LED stylus pen is used each time, the stable brightness of light is developed, enabling the induction to be more stable.

Referring to FIG. 3, when the button 90 is not pushed down, the conductive spring 91 at a bottom end of the button 90 does not touch an anode of the battery A and is away from the battery A by a distance. When the user uses the writing nib 32 to touch a touch screen B (not shown in the drawing), the LED 101 of the writing nib 32 does not emit light. Referring to FIG. 4, when the user pushes down the button 90, the conductive spring 91 is pressed down to touch the anode of the battery A. Referring to FIG. 5, as long as that the user uses the writing nib 32 to touch the touch screen B, the circuit board 100 which is located in the writing nib 32 is connected to a conductor 102 can touch a cathode of the battery A, allowing the LED 31 to emit light. Because the light of the LED 101 from the writing nib 32 be shooting; therefore, the present invention is provided with an advantage that light dots are focused.

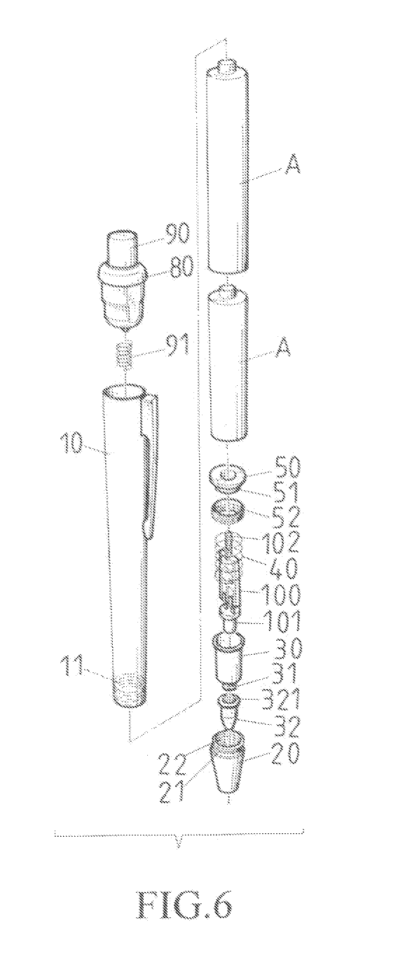

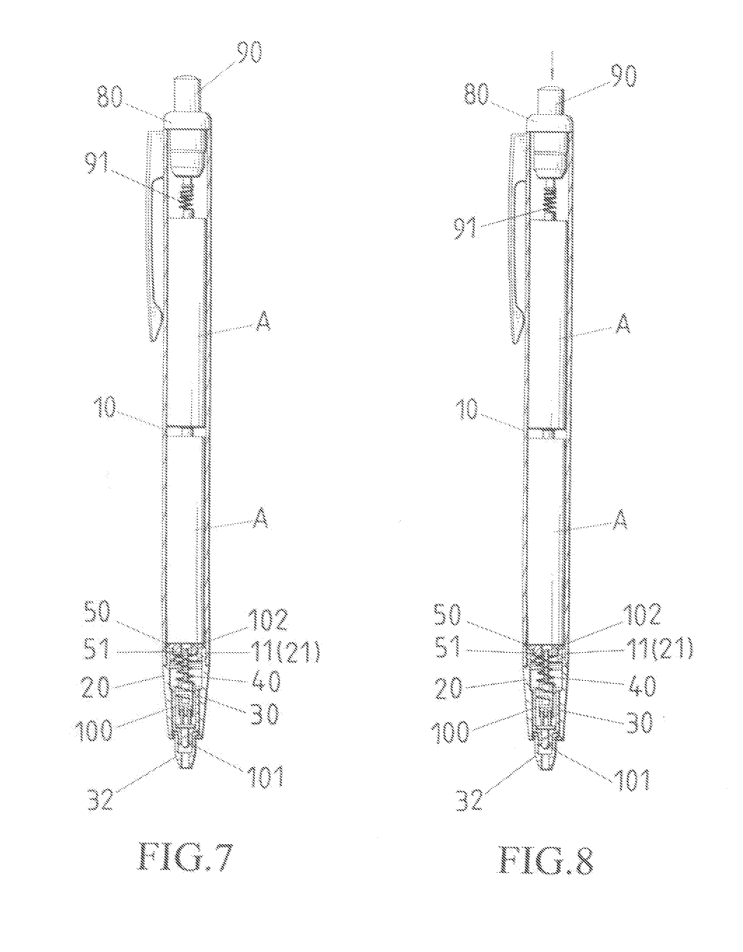

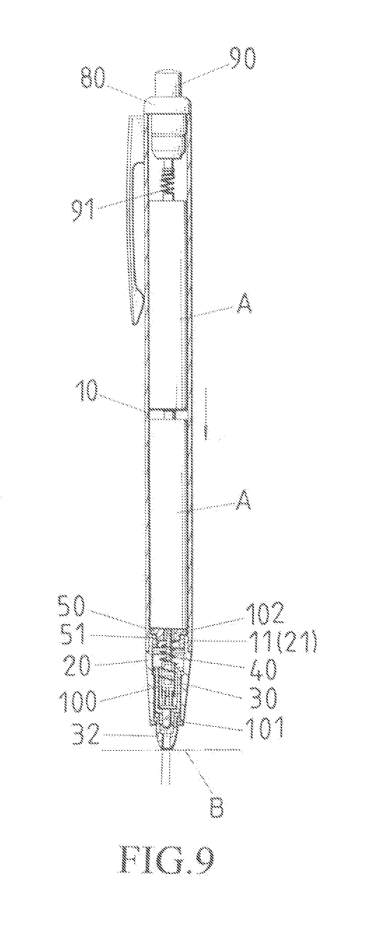

Referring to FIGS. 6 and 7, it shows an exploded view and a cross-sectional view of an embodiment of the present invention, the present invention comprises a penholder 10, a pen nib 20, a lamp tube 30, a first spring 40, a first insulator 50, a metal tube 80 and a button 90. Wherein the button 90 and the conductive spring 91 of the button 90 to become joined as one body with the metal tube 80, wherein an interior of the metal tube 80 is provided with a electric switch (not shown in the drawings), a conductive spring 91 is constant touched the battery A of the penholder 10. Referring to FIG. 8, when the button 90 is pushed down, the electric switch of the metal tube 80 will be actuated, a user uses the writing nib 32 to touch the touch screen B again (as shown in FIG. 9), the conductor 102 at one end of the circuit board 100 can touch the battery A of the penholder 10, allowing the LED 101 to emit light.

Conclusive from the above, in accordance with the present invention, a button is pushed down and a touch screen is touched that power can be provided to an LED to emit light. The button or a switch is defined at topmost of a stylus pen, and the circuit board are located in the lamp tube, a writing nib is connected to the end of the a lamp tube, the LED at one end of the circuit board is located in the lamp tube, such that when a user pushes down the button and actuating the switch, when the user uses the writing nib to touch the touch screen again, so as to provide power to the LED to emit light.

What is claim is:

1. An LED stylus pen comprising a penholder, which is provided with two batteries and an end of which is provided with a threaded hole; a pen nib, which is a hollow structure and an outer thread of which is locked with an inner thread of the penholder; a lamp tube, which is a hollow structure and at one end of which is connected to a writing nib, a writing nib can jut out the pen nib, which is provided with a circuit board, the circuit board is latched with an LED, and the other end of the circuit board being connected to a conductor; a first spring which is sheathed at an exterior side of the conductor of the lamp tube and is locked into the lamp tube; a first insulator which is sheathed at an end of the first spring and at one end of which is connected to a metal screw ring, the metal screw ring being locked at an opening end of the pen nib to be insulated with a conductor of the circuit board and thus to be conducted with the first spring; a metal tube which is a hollow structure and is latched at a bottom end of a tube opening above the penholder, and is abutted on the second spring; and a button, which transfixes the metal tube and a bottom end of which is sheathed with a conductive spring, with the conductive spring transfixing the second spring and the second insulator to touch the upper-side battery; a user pushing down the button to actuate the switch of the LED and when the user using the writing nib to touch a touch screen again, the conductor of the circuit board touching the lower-side battery to allow the LED to emit light.

2. The LED stylus pen according to claim 1, wherein a center of the circuit board is provided with a booster IC and two sides are provided respectively with a capacitance and an inductor; a booster IC controls stability of the current, allowing a capacity of the battery to be used to a limit.

3. The LED stylus pen according to claim 1, wherein a lower end of the metal tube is provided with a second spring and a second insulator, the conductive spring of the button transfixes the second spring and a second insulator; a user pushing down the button to press down the conductive spring to touch the upper-side battery and actuating the switch, when the button is pushed again and can bounce back the button to an original position.

4. The LED stylus pen according to claim 1, wherein an interior of the metal tube is provided with a electric switch, a conductive spring is constant touched the battery of the penholder.
